(19) United States
(12) Patent Application Publication
(10) Pub. No.: US 2021/0065098 A1
(43) Pub. Date: Mar. 4, 2021

(54) COMPUTERIZED SYSTEMS AND METHODS FOR DISPLAY AND DETERMINATION OF GUARANTEED DELIVERY TIME SELECTION

(71) Applicant: Coupang, Corp., Seoul (KR)

(72) Inventors: Chang Hyun Park, Seoul (KR); Daniel Kim, Seoul (KR)

(73) Assignee: Coupang, Corp.

(21) Appl. No.: 16/558,851

(22) Filed: Sep. 3, 2019

(51) Int. Cl. G06Q 10/08; G06Q 10/10; G06F 16/909; G06F 16/904

(52) U.S. Cl. CPC G06Q 10/083; G06Q 10/1097; G06F 16/904; G06F 16/909; G06Q 10/087

(57) ABSTRACT

Systems and methods are provided for automatically determining guaranteed delivery times and generating a calendar of the guaranteed delivery times for user selection. One method comprises receiving, from a user device, a request for an order, the request including product information and location information. The method further comprises searching a database using the location information to determine available times for delivering a product associated with the product information, the database comprising location data, product data, and time data and determining, based on a comparison of the location data and the received location information, available times for delivering the product. The method further comprises presenting a visual display of guaranteed available times for delivery of the product, based on the determined available times; receiving, from the user device, a selection of an available time; and based on the selected available time, sending an indication that the order has processed the determined available time.

### TECHNICAL FIELD

The present disclosure generally relates to computerized systems and methods for automatically determining guaranteed delivery times for user selection. In particular, embodiments of the present disclosure relate to inventive and unconventional systems for generating a calendar of guaranteed delivery times based on a user's location information (e.g., delivery location zip code) and virtually swapping the inventory of one or more warehouses to provide the most cost-effective delivery options.

### BACKGROUND

Many consumers shop for and order products online for delivery to their homes for convenience. Due to the weight and dimension constraints of certain products and the installation requirements of certain product types (e.g., refrigerators, air conditioning units, etc.), special deliveries may be required to fulfill a consumer's order. Because special deliveries may require more time to deliver to the consumer or an engineer to install the product in the consumer's home, consumers of these special delivery products may have specific preferences for the delivery time of the product.

The existing methods for providing delivery times for consumers, however, are unreliable. They provide an option for consumers to input a desired delivery date as a delivery note when they order a product, but this delivery note does not guarantee an actual delivery date that matches the consumer's request. As a result, consumers may wait long periods of time for their product to be delivered, only to have the product delivered several days late.

Requiring consumers to manually input a desired delivery date on an electronic form may lead to inaccuracies in a consumer's order request. For example, consumers may input a date in one country's date format when the order page requires a different country's date format (e.g., mm/dd/yy versus dd/mm/yy). The customer may also write out the date in a form that would not be recognized by automated systems (e.g., “the Monday after next,” “two weeks from yesterday,” or “three weeks from tomorrow”).

Therefore, there is a need for improved methods and systems for automatically determining guaranteed delivery times and generating a calendar of the guaranteed delivery times for consumer selection.

### SUMMARY

One aspect of the present disclosure is directed to an electronic system for multi-computer logistics coordination. The system may comprise at least one processor and at least one non transitory storage medium comprising instructions that, when executed by the at least one processor, cause the at least one processor to perform steps. The steps may comprise receiving, from a user device, a request for an order, the request including product information and location information; searching a database using the location information to determine available times for delivering a product associated with the product information, the database comprising location data, product data, and time data; and determining, based on a comparison of the location data and the received location information, available times for delivering the product. The steps may comprise presenting a visual display of guaranteed available times for delivery of the product, based on the determined available times; receiving, from the user device, a selection of an available time; and based on the selected available time, sending an indication that the order is processed the determined available time.

Another aspect of the present disclosure is directed to a method for generating a calendar of guaranteed delivery times for user selection. The method may comprise receiving, from a user device, a request for an order, the request including product information and location information; searching a database using the location information to determine available times for delivering a product associated with the product information, the database comprising location data, product data, and time data; and determining, based on a comparison of the location data and the received location information, available times for delivering the product. The method may comprise presenting a visual display of guaranteed available times for delivery of the product, based on the determined available times; receiving, from the user device, a selection of an available time; and based on the selected available time, sending an indication that the order is processed the determined available time.

Yet another aspect of the present disclosure is directed to an electronic system for multi-computer logistics coordination. The system may comprise at least one processor and at least one non transitory storage medium comprising instructions that, when executed by the at least one processor, cause the at least one processor to perform steps. The steps may comprise receiving, from a user device, a request for an order, the request including product information and location information; searching a database using the location information to determine available times for delivering a product associated with the product information, the database comprising location data, product data, and time data; and determining, based on a comparison of the location data and the received location information, available times for delivering the product. The steps may comprise presenting a visual display of guaranteed available times for delivery of the product, based on the determined available times; wherein the visual display comprises a calendar and the guaranteed available times for delivery of the product are highlighted on the calendar; receiving, from the user device, a selection of an available time; and based on the selected available time, sending an indication that the order is processed the determined available time.

Other systems, methods, and computer-readable media are also discussed herein.

### BRIEF DESCRIPTION OF THE DRAWINGS

FIG. 1A is a schematic block diagram illustrating an exemplary embodiment of a network comprising computerized systems for communications enabling shipping, transportation, and logistics operations, consistent with the disclosed embodiments.

FIG. 1B depicts a sample Search Result Page (SRP) that includes one or more search results satisfying a search request along with interactive user interface elements, consistent with the disclosed embodiments.

FIG. 1C depicts a sample Single Display Page (SDP) that includes a product and information about the product along with interactive user interface elements, consistent with the disclosed embodiments.

FIG. 1D depicts a sample Cart page that includes items in a virtual shopping cart along with interactive user interface elements, consistent with the disclosed embodiments.

FIG. 1E depicts a sample Order page that includes items from the virtual shopping cart along with information regarding purchase and shipping, along with interactive user interface elements, consistent with the disclosed embodiments.

FIG. 2 is a diagrammatic illustration of an exemplary fulfillment center configured to utilize disclosed computerized systems, consistent with the disclosed embodiments.

FIG. 3 depicts a sample calendar of guaranteed delivery dates displayed on a user device, consistent with the disclosed embodiments.

FIG. 4 depicts another sample calendar of guaranteed delivery dates displayed on a user device, consistent with the disclosed embodiments.

FIG. 5 depicts a process for providing guaranteed delivery dates to a user device, consistent with the disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

Embodiments of the present disclosure are directed to systems and methods configured for automatically determining guaranteed delivery times and generating a calendar of the guaranteed times for consumer selection. The disclosed embodiments are advantageously capable of generating a calendar of guaranteed delivery times using product information and location information from a user's request. Product information may include a product identifier while location information may include an address or zip code of the location to which the product is to be delivered. Since a calendar of guaranteed delivery times will be generated, the request may not include a desired delivery time.

In one implementation, a user device may send a request for an order to an external front end system. Upon receiving the request from the external front end system, a database may be searched using the location information from the request. The database may include location data, product data, and time data. Location data may include the zip code and locations of warehouses containing the requested product. Product data may include a product identifier and inventory of the requested product in warehouses. Time data may include data about the delivery staff, delivery schedule, and delivery route. Guaranteed delivery times of the product may be calculated based on a comparison of the location data and the received location information. The guaranteed delivery times may be sent to the user device in a calendar format. The calendar may highlight the available guaranteed delivery times, allowing the user to select their desired guaranteed delivery time. A user interface element may then send the user's selection to the external front end system for processing the requested order. The external front end system may send an indication to the user device that the requested order, including the selected guaranteed delivery time, has been processed.

In some embodiments, the database may determine whether an inventory value of the request and its associated zip code are constrained. A constrained inventory value and zip code may be one where the zip code of the delivery location is outside the radius of a metropolitan area. The database may update all inventory data periodically (e.g., once per day, once per hour, etc.) in order to determine accurate guaranteed delivery times using up-to-date inventory and zip code data. Accordingly, the database may update available dates for each zip code associated with the inventory.

In some other embodiments, the external front end system may virtually swap inventory between one or more warehouses to provide the most cost-effective deliveries. For example, the external front end system may determine that delivering a product from a first warehouse owned by a vendor is less expensive and faster than delivering the same product from a second warehouse owned by the vendor. Upon making this determination, the database may automatically update so that the vendor's inventory in the first warehouse has increased by one unit of the product and the vendor's inventory in the second warehouse has decreased by one unit of the product.

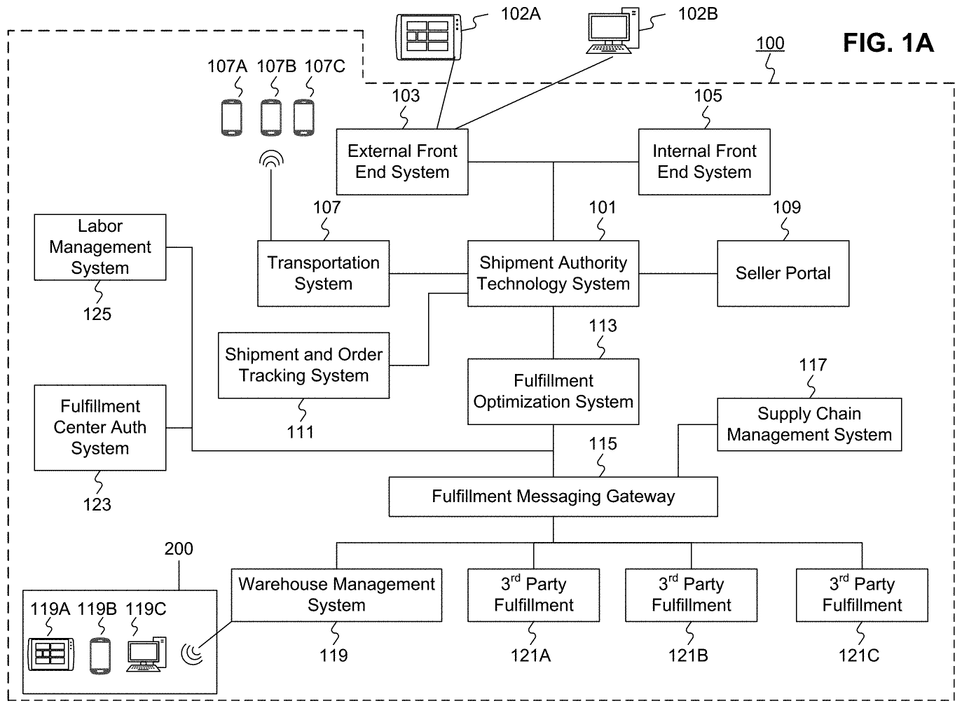

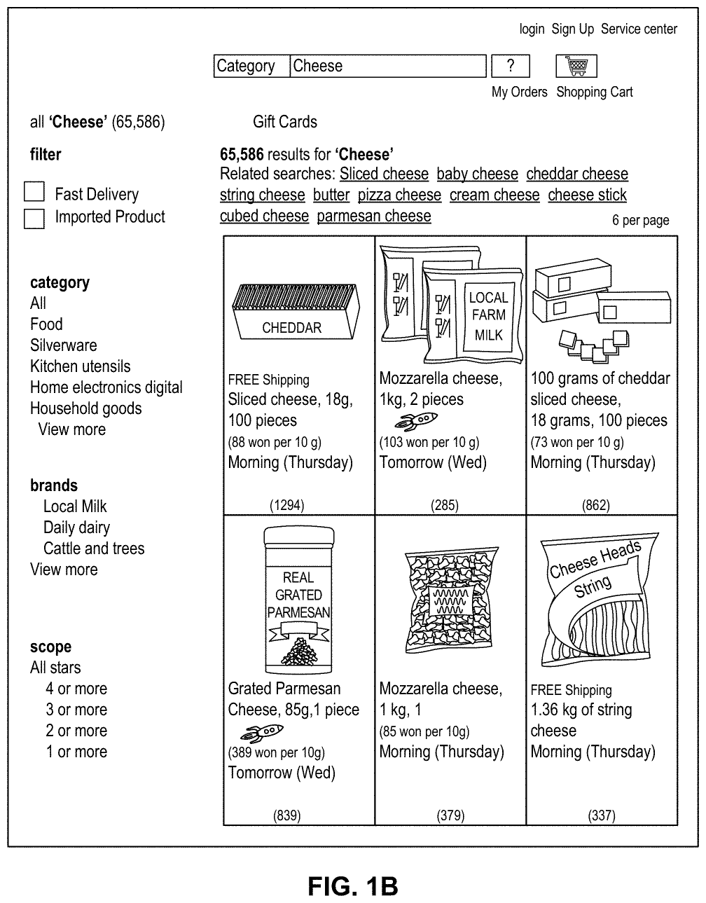

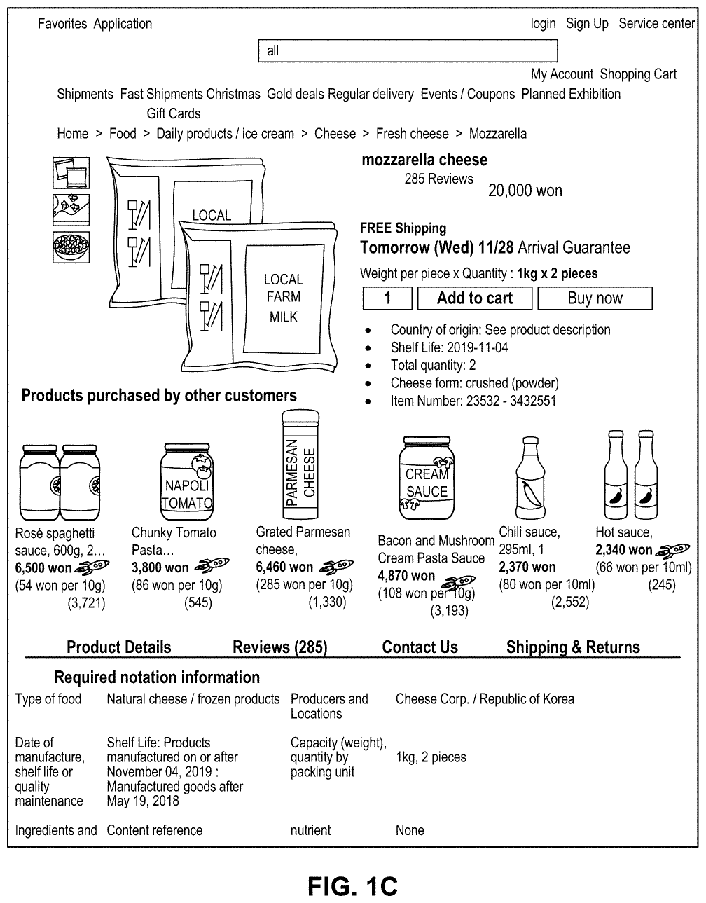

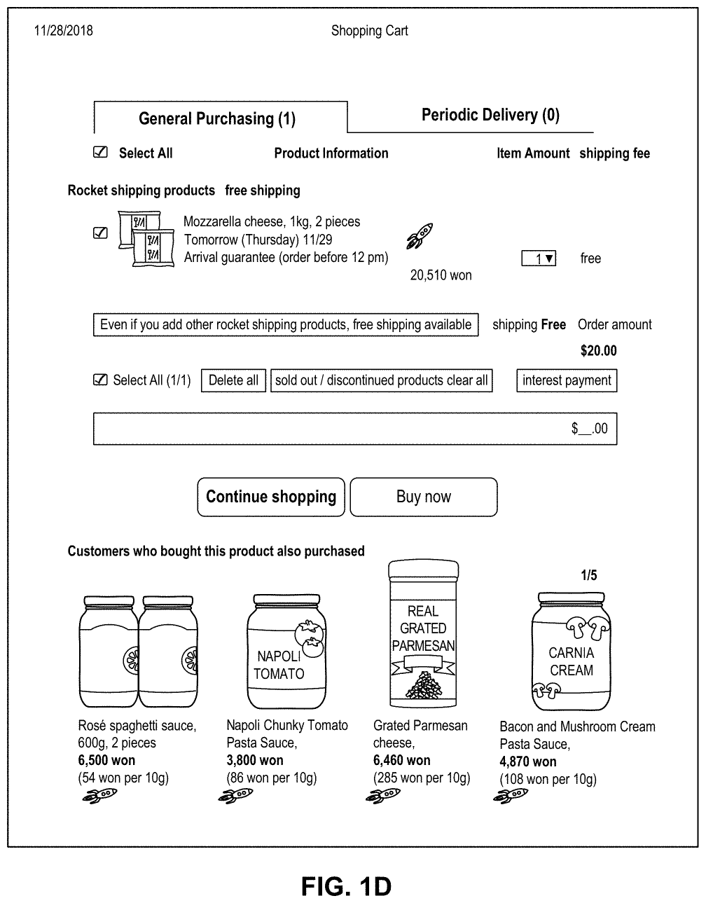

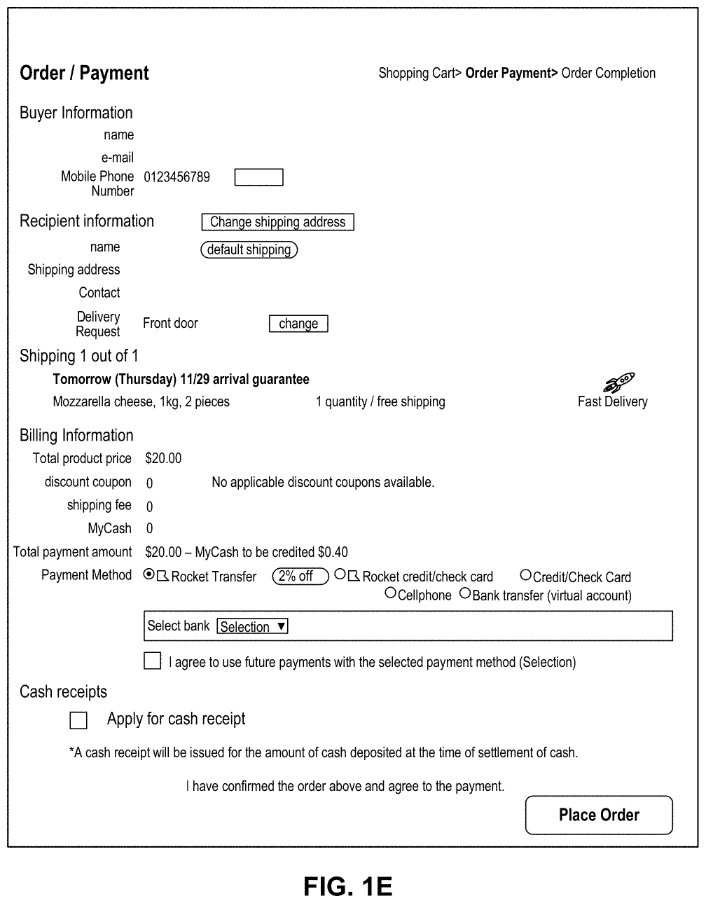

Referring to FIG. 1A, a schematic block diagram 100 illustrating an exemplary embodiment of a system comprising computerized systems for communications enabling shipping, transportation, and logistics operations is shown. As illustrated in FIG. 1A, system 100 may include a variety of systems, each of which may be connected to one another via one or more networks. The systems may also be connected to one another via a direct connection, for example, using a cable. The depicted systems include a shipment authority technology (SAT) system 101, an external front end system 103, an internal front end system 105, a transportation system 107, mobile devices 107A, 107B, and 107C, seller portal 109, shipment and order tracking (SOT) system 111, fulfillment optimization (FO) system 113, fulfillment messaging gateway (FMG) 115, supply chain management (SCM) system 117, warehouse management system 119, mobile devices 119A, 119B, and 119C (depicted as being inside of fulfillment center (FC) 200), 3^{rd} party fulfillment systems 121A, 121B, and 121C, fulfillment center authorization system (FC Auth) 123, and labor management system (LMS) 125.

SAT system 101, in some embodiments, may be implemented as a computer system that monitors order status and delivery status. For example, SAT system 101 may determine whether an order is past its Promised Delivery Date (PDD) and may take appropriate action, including initiating a new order, reshipping the items in the non-delivered order, canceling the non-delivered order, initiating contact with the ordering customer, or the like. SAT system 101 may also monitor other data, including output (such as a number of packages shipped during a particular time period) and input (such as the number of empty cardboard boxes received for use in shipping). SAT system 101 may also act as a gateway between different devices in system 100, enabling communication (e.g., using store-and-forward or other techniques) between devices such as external front end system 103 and FO system 113.

External front end system 103, in some embodiments, may be implemented as a computer system that enables external users to interact with one or more systems in system 100. For example, in embodiments where system 100 enables the presentation of systems to enable users to place an order for an item, external front end system 103 may be implemented as a web server that receives search requests, presents item pages, and solicits payment information. For example, external front end system 103 may be implemented as a computer or computers running software such as the Apache HTTP Server, Microsoft Internet Information Services (IIS), NGINX, or the like. In other embodiments, external front end system 103 may run custom web server software designed to receive and process requests from external devices (e.g., mobile device 102A or computer 102B), acquire information from databases and other data stores based on those requests, and provide responses to the received requests based on acquired information.

In some embodiments, external front end system 103 may include one or more of a web caching system, a database, a search system, or a payment system. In one aspect, external front end system 103 may comprise one or more of these systems, while in another aspect, external front end system 103 may comprise interfaces (e.g., server-to-server, database-to-database, or other network connections) connected to one or more of these systems.

An illustrative set of steps, illustrated by FIGS. 1B, 1C, 1D, and 1E, will help to describe some operations of external front end system 103. External front end system 103 may receive information from systems or devices in system 100 for presentation and/or display. For example, external front end system 103 may host or provide one or more web pages, including a Search Result Page (SRP) (e.g., FIG. 1B), a Single Detail Page (SDP) (e.g., FIG. 1C), a Cart page (e.g., FIG. 1D), or an Order page (e.g., FIG. 1E). A user device (e.g., using mobile device 102A or computer 102B) may navigate to external front end system 103 and request a search by entering information into a search box. External front end system 103 may request information from one or more systems in system 100. For example, external front end system 103 may request information from FO System 113 that satisfies the search request. External front end system 103 may also request and receive (from FO System 113) a Promised Delivery Date or “PDD” for each product included in the search results. The PDD, in some embodiments, may represent an estimate of when a package containing the product will arrive at the user's desired location or a date by which the product is promised to be delivered at the user's desired location if ordered within a particular period of time, for example, by the end of the day (11:59 PM). (PDD is discussed further below with respect to FO System 113.)

External front end system 103 may prepare an SRP (e.g., FIG. 1B) based on the information. The SRP may include information that satisfies the search request. For example, this may include pictures of products that satisfy the search request. The SRP may also include respective prices for each product, or information relating to enhanced delivery options for each product, PDD, weight, size, offers, discounts, or the like. External front end system 103 may send the SRP to the requesting user device (e.g., via a network).

A user device may then select a product from the SRP, e.g., by clicking or tapping a user interface, or using another input device, to select a product represented on the SRP. The user device may formulate a request for information on the selected product and send it to external front end system 103. In response, external front end system 103 may request information related to the selected product. For example, the information may include additional information beyond that presented for a product on the respective SRP. This could include, for example, shelf life, country of origin, weight, size, number of items in package, handling instructions, or other information about the product. The information could also include recommendations for similar products (based on, for example, big data and/or machine learning analysis of customers who bought this product and at least one other product), answers to frequently asked questions, reviews from customers, manufacturer information, pictures, or the like.

External front end system 103 may prepare an SDP (Single Detail Page) (e.g., FIG. 1C) based on the received product information. The SDP may also include other interactive elements such as a “Buy Now” button, a “Add to Cart” button, a quantity field, a picture of the item, or the like. The SDP may further include a list of sellers that offer the product. The list may be ordered based on the price each seller offers such that the seller that offers to sell the product at the lowest price may be listed at the top. The list may also be ordered based on the seller ranking such that the highest ranked seller may be listed at the top. The seller ranking may be formulated based on multiple factors, including, for example, the seller's past track record of meeting a promised PDD. External front end system 103 may deliver the SDP to the requesting user device (e.g., via a network).

The requesting user device may receive the SDP which lists the product information. Upon receiving the SDP, the user device may then interact with the SDP. For example, a user of the requesting user device may click or otherwise interact with a “Place in Cart” button on the SDP. This adds the product to a shopping cart associated with the user. The user device may transmit this request to add the product to the shopping cart to external front end system 103.

External front end system 103 may generate a Cart page (e.g., FIG. 1D). The Cart page, in some embodiments, lists the products that the user has added to a virtual “shopping cart.” A user device may request the Cart page by clicking on or otherwise interacting with an icon on the SRP, SDP, or other pages. The Cart page may, in some embodiments, list all products that the user has added to the shopping cart, as well as information about the products in the cart such as a quantity of each product, a price for each product per item, a price for each product based on an associated quantity, information regarding PDD, a delivery method, a shipping cost, user interface elements for modifying the products in the shopping cart (e.g., deletion or modification of a quantity), options for ordering other product or setting up periodic delivery of products, options for setting up interest payments, user interface elements for proceeding to purchase, or the like. A user at a user device may click on or otherwise interact with a user interface element (e.g., a button that reads “Buy Now”) to initiate the purchase of the product in the shopping cart. Upon doing so, the user device may transmit this request to initiate the purchase to external front end system 103.

External front end system 103 may generate an Order page (e.g., FIG. 1E) in response to receiving the request to initiate a purchase. The Order page, in some embodiments, re-lists the items from the shopping cart and requests input of payment and shipping information. For example, the Order page may include a section requesting information about the purchaser of the items in the shopping cart (e.g., name, address, e-mail address, phone number), information about the recipient (e.g., name, address, phone number, delivery information), shipping information (e.g., speed/method of delivery and/or pickup), payment information (e.g., credit card, bank transfer, check, stored credit), user interface elements to request a cash receipt (e.g., for tax purposes), or the like. External front end system 103 may send the Order page to the user device.

In some embodiments, external front end system 103 may be further configured to enable sellers to transmit and receive information relating to orders.

Internal front end system 105, in some embodiments, may be implemented as a computer system that enables internal users (e.g., employees of an organization that owns, operates, or leases system 100) to interact with one or more systems in system 100. For example, in embodiments where network 101 enables the presentation of systems to enable users to place an order for an item, internal front end system 105 may be implemented as a web server that enables internal users to view diagnostic and statistical information about orders, modify item information, or review statistics relating to orders. For example, internal front end system 105 may be implemented as a computer or computers running software such as the Apache HTTP Server, Microsoft Internet Information Services (IIS), NGINX, or the like. In other embodiments, internal front end system 105 may run custom web server software designed to receive and process requests from systems or devices depicted in system 100 (as well as other devices not depicted), acquire information from databases and other data stores based on those requests, and provide responses to the received requests based on acquired information.

In some embodiments, internal front end system 105 may include one or more of a web caching system, a database, a search system, a payment system, an analytics system, an order monitoring system, or the like. In one aspect, internal front end system 105 may comprise one or more of these systems, while in another aspect, internal front end system 105 may comprise interfaces (e.g., server-to-server, database-to-database, or other network connections) connected to one or more of these systems.

Transportation system 107, in some embodiments, may be implemented as a computer system that enables communication between systems or devices in system 100 and mobile devices 107A-107C. Transportation system 107, in some embodiments, may receive information from one or more mobile devices 107A-107C (e.g., mobile phones, smart phones, PDAs, or the like). For example, in some embodiments, mobile devices 107A-107C may comprise devices operated by delivery workers. The delivery workers, who may be permanent, temporary, or shift employees, may utilize mobile devices 107A-107C to effect delivery of packages containing the products ordered by users. For example, to deliver a package, the delivery worker may receive a notification on a mobile device indicating which package to deliver and where to deliver it. Upon arriving at the delivery location, the delivery worker may locate the package (e.g., in the back of a truck or in a crate of packages), scan or otherwise capture data associated with an identifier on the package (e.g., a barcode, an image, a text string, an RFID tag, or the like) using the mobile device, and deliver the package (e.g., by leaving it at a front door, leaving it with a security guard, handing it to the recipient, or the like). In some embodiments, the delivery worker may capture photo(s) of the package and/or may obtain a signature using the mobile device. The mobile device may send information to transportation system 107 including information about the delivery, including, for example, time, date, GPS location, photo(s), an identifier associated with the delivery worker, an identifier associated with the mobile device, or the like. Transportation system 107 may store this information in a database (not pictured) for access by other systems in system 100. Transportation system 107 may, in some embodiments, use this information to prepare and send tracking data to other systems indicating the location of a particular package.

In some embodiments, certain users may use one kind of mobile device (e.g., permanent workers may use a specialized PDA with custom hardware such as a barcode scanner, stylus, and other devices) while other users may use other kinds of mobile devices (e.g., temporary or shift workers may utilize off-the-shelf mobile phones and/or smartphones).

In some embodiments, transportation system 107 may associate a user with each device. For example, transportation system 107 may store an association between a user (represented by, e.g., a user identifier, an employee identifier, or a phone number) and a mobile device (represented by, e.g., an International Mobile Equipment Identity (IMEI), an International Mobile Subscription Identifier (IMSI), a phone number, a Universal Unique Identifier (UUID), or a Globally Unique Identifier (GUID)). Transportation system 107 may use this association in conjunction with data received on deliveries to analyze data stored in the database in order to determine, among other things, a location of the worker, an efficiency of the worker, or a speed of the worker.

Seller portal 109, in some embodiments, may be implemented as a computer system that enables sellers or other external entities to electronically communicate with one or more systems in system 100. For example, a seller may utilize a computer system (not pictured) to upload or provide product information, order information, contact information, or the like, for products that the seller wishes to sell through system 100 using seller portal 109.

Shipment and order tracking system 111, in some embodiments, may be implemented as a computer system that receives, stores, and forwards information regarding the location of packages containing products ordered by customers (e.g., by a user using devices 102A-102B). In some embodiments, shipment and order tracking system 111 may request or store information from web servers (not pictured) operated by shipping companies that deliver packages containing products ordered by customers.

In some embodiments, shipment and order tracking system 111 may request and store information from systems depicted in system 100. For example, shipment and order tracking system 111 may request information from transportation system 107. As discussed above, transportation system 107 may receive information from one or more mobile devices 107A-107C (e.g., mobile phones, smart phones, PDAs, or the like) that are associated with one or more of a user (e.g., a delivery worker) or a vehicle (e.g., a delivery truck). In some embodiments, shipment and order tracking system 111 may also request information from warehouse management system (WMS) 119 to determine the location of individual products inside of a fulfillment center (e.g., fulfillment center 200). Shipment and order tracking system 111 may request data from one or more of transportation system 107 or WMS 119, process it, and present it to a device (e.g., user devices 102A and 102B) upon request.

Fulfillment optimization (FO) system 113, in some embodiments, may be implemented as a computer system that stores information for customer orders from other systems (e.g., external front end system 103 and/or shipment and order tracking system 111). FO system 113 may also store information describing where particular items are held or stored. For example, certain items may be stored only in one fulfillment center, while certain other items may be stored in multiple fulfillment centers. In still other embodiments, certain fulfilment centers may be designed to store only a particular set of items (e.g., fresh produce or frozen products). FO system 113 stores this information as well as associated information (e.g., quantity, size, date of receipt, expiration date, etc.).

FO system 113 may also calculate a corresponding PDD (promised delivery date) for each product. The PDD, in some embodiments, may be based on one or more factors. For example, FO system 113 may calculate a PDD for a product based on a past demand for a product (e.g., how many times that product was ordered during a period of time), an expected demand for a product (e.g., how many customers are forecast to order the product during an upcoming period of time), a network-wide past demand indicating how many products were ordered during a period of time, a network-wide expected demand indicating how many products are expected to be ordered during an upcoming period of time, one or more counts of the product stored in each fulfillment center 200, which fulfillment center stores each product, expected or current orders for that product, or the like.

Fulfilment messaging gateway (FMG) 115, in some embodiments, may be implemented as a computer system that receives a request or response in one format or protocol from one or more systems in system 100, such as FO system 113, converts it to another format or protocol, and forward it in the converted format or protocol to other systems, such as WMS 119 or 3rd party fulfillment systems 121A, 121B, or 121C, and vice versa.

Supply chain management (SCM) system 117, in some embodiments, may be implemented as a computer system that performs forecasting functions. For example, SCM system 117 may forecast a level of demand for a particular product based on, for example, based on a past demand for products, an expected demand for a product, a network-wide past demand, a network-wide expected demand, a count products stored in each fulfillment center 200, expected or current orders for each product, or the like. In response to this forecasted level and the amount of each product across all fulfillment centers, SCM system 117 may generate one or more purchase orders to purchase and stock a sufficient quantity to satisfy the forecasted demand for a particular product.

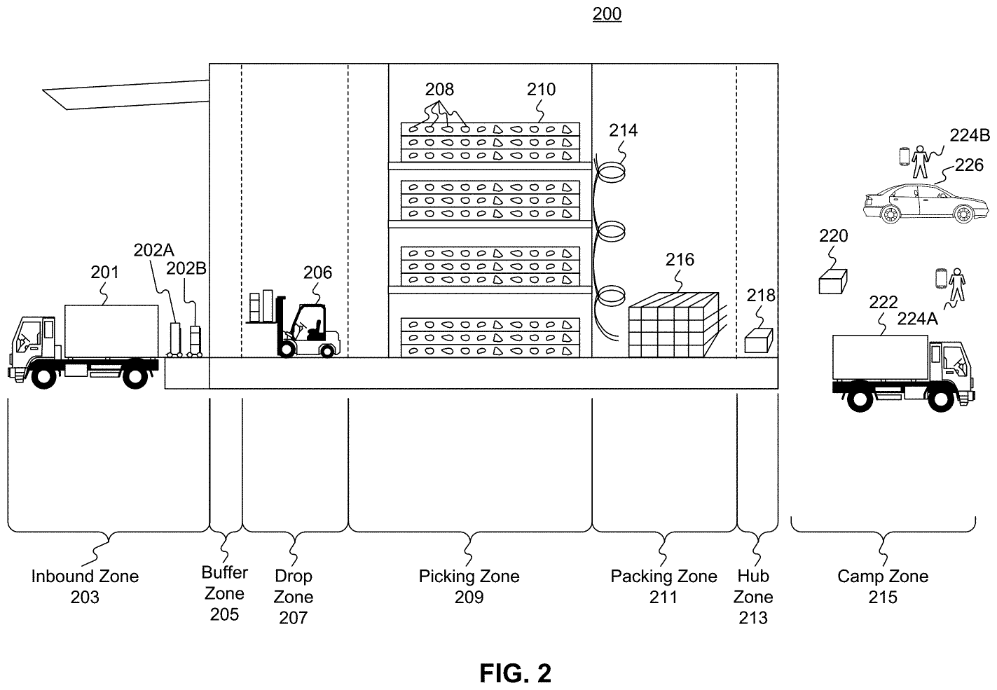

Warehouse management system (WMS) 119, in some embodiments, may be implemented as a computer system that monitors workflow. For example, WMS 119 may receive event data from individual devices (e.g., devices 107A-107C or 119A-119C) indicating discrete events. For example, WMS 119 may receive event data indicating the use of one of these devices to scan a package. As discussed below with respect to fulfillment center 200 and FIG. 2, during the fulfillment process, a package identifier (e.g., a barcode or RFID tag data) may be scanned or read by machines at particular stages (e.g., automated or handheld barcode scanners, RFID readers, high-speed cameras, devices such as tablet 119A, mobile device/PDA 119B, computer 119C, or the like). WMS 119 may store each event indicating a scan or a read of a package identifier in a corresponding database (not pictured) along with the package identifier, a time, date, location, user identifier, or other information, and may provide this information to other systems (e.g., shipment and order tracking system 111).

WMS 119, in some embodiments, may store information associating one or more devices (e.g., devices 107A-107C or 119A-119C) with one or more users associated with system 100. For example, in some situations, a user (such as a part- or full-time employee) may be associated with a mobile device in that the user owns the mobile device (e.g., the mobile device is a smartphone). In other situations, a user may be associated with a mobile device in that the user is temporarily in custody of the mobile device (e.g., the user checked the mobile device out at the start of the day, will use it during the day, and will return it at the end of the day).

WMS 119, in some embodiments, may maintain a work log for each user associated with system 100. For example, WMS 119 may store information associated with each employee, including any assigned processes (e.g., unloading trucks, picking items from a pick zone, rebin wall work, packing items), a user identifier, a location (e.g., a floor or zone in a fulfillment center 200), a number of units moved through the system by the employee (e.g., number of items picked, number of items packed), an identifier associated with a device (e.g., devices 119A-119C), or the like. In some embodiments, WMS 119 may receive check-in and check-out information from a timekeeping system, such as a timekeeping system operated on a device 119A-119C.

3rd party fulfillment (3PL) systems 121A-121C, in some embodiments, represent computer systems associated with third-party providers of logistics and products. For example, while some products are stored in fulfillment center 200 (as discussed below with respect to FIG. 2), other products may be stored off-site, may be produced on demand, or may be otherwise unavailable for storage in fulfillment center 200. 3PL systems 121A-121C may be configured to receive orders from FO system 113 (e.g., through FMG 115) and may provide products and/or services (e.g., delivery or installation) to customers directly. In some embodiments, one or more of 3PL systems 121A-121C may be part of system 100, while in other embodiments, one or more of 3PL systems 121A-121C may be outside of system 100 (e.g., owned or operated by a third-party provider).

Fulfillment Center Auth system (FC Auth) 123, in some embodiments, may be implemented as a computer system with a variety of functions. For example, in some embodiments, FC Auth 123 may act as a single-sign on (SSO) service for one or more other systems in system 100. For example, FC Auth 123 may enable a user to log in via internal front end system 105, determine that the user has similar privileges to access resources at shipment and order tracking system 111, and enable the user to access those privileges without requiring a second log in process. FC Auth 123, in other embodiments, may enable users (e.g., employees) to associate themselves with a particular task. For example, some employees may not have an electronic device (such as devices 119A-119C) and may instead move from task to task, and zone to zone, within a fulfillment center 200, during the course of a day. FC Auth 123 may be configured to enable those employees to indicate what task they are performing and what zone they are in at different times of day.

Labor management system (LMS) 125, in some embodiments, may be implemented as a computer system that stores attendance and overtime information for employees (including full-time and part-time employees). For example, LMS 125 may receive information from FC Auth 123, WMA 119, devices 119A-119C, transportation system 107, and/or devices 107A-107C.

The particular configuration depicted in FIG. 1A is an example only. For example, while FIG. 1A depicts FC Auth system 123 connected to FO system 113, not all embodiments require this particular configuration. Indeed, in some embodiments, the systems in system 100 may be connected to one another through one or more public or private networks, including the Internet, an Intranet, a WAN (Wide-Area Network), a MAN (Metropolitan-Area Network), a wireless network compliant with the IEEE 802.11a/b/g/n Standards, a leased line, or the like. In some embodiments, one or more of the systems in system 100 may be implemented as one or more virtual servers implemented at a data center, server farm, or the like.

FIG. 2 depicts a fulfillment center 200. Fulfillment center 200 is an example of a physical location that stores items for shipping to customers when ordered. Fulfillment center (FC) 200 may be divided into multiple zones, each of which are depicted in FIG. 2. These “zones,” in some embodiments, may be thought of as virtual divisions between different stages of a process of receiving items, storing the items, retrieving the items, and shipping the items. So while the “zones” are depicted in FIG. 2, other divisions of zones are possible, and the zones in FIG. 2 may be omitted, duplicated, or modified in some embodiments.

Inbound zone 203 represents an area of FC 200 where items are received from sellers who wish to sell products using system 100 from FIG. 1A. For example, a seller may deliver items 202A and 202B using truck 201. Item 202A may represent a single item large enough to occupy its own shipping pallet, while item 202B may represent a set of items that are stacked together on the same pallet to save space.

A worker will receive the items in inbound zone 203 and may optionally check the items for damage and correctness using a computer system (not pictured). For example, the worker may use a computer system to compare the quantity of items 202A and 202B to an ordered quantity of items. If the quantity does not match, that worker may refuse one or more of items 202A or 202B. If the quantity does match, the worker may move those items (using, e.g., a dolly, a handtruck, a forklift, or manually) to buffer zone 205. Buffer zone 205 may be a temporary storage area for items that are not currently needed in the picking zone, for example, because there is a high enough quantity of that item in the picking zone to satisfy forecasted demand. In some embodiments, forklifts 206 operate to move items around buffer zone 205 and between inbound zone 203 and drop zone 207. If there is a need for items 202A or 202B in the picking zone (e.g., because of forecasted demand), a forklift may move items 202A or 202B to drop zone 207.

Drop zone 207 may be an area of FC 200 that stores items before they are moved to picking zone 209. A worker assigned to the picking task (a “picker”) may approach items 202A and 202B in the picking zone, scan a barcode for the picking zone, and scan barcodes associated with items 202A and 202B using a mobile device (e.g., device 119B). The picker may then take the item to picking zone 209 (e.g., by placing it on a cart or carrying it).

Picking zone 209 may be an area of FC 200 where items 208 are stored on storage units 210. In some embodiments, storage units 210 may comprise one or more of physical shelving, bookshelves, boxes, totes, refrigerators, freezers, cold stores, or the like. In some embodiments, picking zone 209 may be organized into multiple floors. In some embodiments, workers or machines may move items into picking zone 209 in multiple ways, including, for example, a forklift, an elevator, a conveyor belt, a cart, a handtruck, a dolly, an automated robot or device, or manually. For example, a picker may place items 202A and 202B on a handtruck or cart in drop zone 207 and walk items 202A and 202B to picking zone 209.

A picker may receive an instruction to place (or “stow”) the items in particular spots in picking zone 209, such as a particular space on a storage unit 210. For example, a picker may scan item 202A using a mobile device (e.g., device 119B). The device may indicate where the picker should stow item 202A, for example, using a system that indicate an aisle, shelf, and location. The device may then prompt the picker to scan a barcode at that location before stowing item 202A in that location. The device may send (e.g., via a wireless network) data to a computer system such as WMS 119 in FIG. 1A indicating that item 202A has been stowed at the location by the user using device 1196.

Once a user places an order, a picker may receive an instruction on device 119B to retrieve one or more items 208 from storage unit 210. The picker may retrieve item 208, scan a barcode on item 208, and place it on transport mechanism 214. While transport mechanism 214 is represented as a slide, in some embodiments, transport mechanism may be implemented as one or more of a conveyor belt, an elevator, a cart, a forklift, a handtruck, a dolly, a cart, or the like. Item 208 may then arrive at packing zone 211.

Packing zone 211 may be an area of FC 200 where items are received from picking zone 209 and packed into boxes or bags for eventual shipping to customers. In packing zone 211, a worker assigned to receiving items (a “rebin worker”) will receive item 208 from picking zone 209 and determine what order it corresponds to. For example, the rebin worker may use a device, such as computer 119C, to scan a barcode on item 208. Computer 119C may indicate visually which order item 208 is associated with. This may include, for example, a space or “cell” on a wall 216 that corresponds to an order. Once the order is complete (e.g., because the cell contains all items for the order), the rebin worker may indicate to a packing worker (or “packer”) that the order is complete. The packer may retrieve the items from the cell and place them in a box or bag for shipping. The packer may then send the box or bag to a hub zone 213, e.g., via forklift, cart, dolly, handtruck, conveyor belt, manually, or otherwise.

Hub zone 213 may be an area of FC 200 that receives all boxes or bags (“packages”) from packing zone 211. Workers and/or machines in hub zone 213 may retrieve package 218 and determine which portion of a delivery area each package is intended to go to, and route the package to an appropriate camp zone 215. For example, if the delivery area has two smaller sub-areas, packages will go to one of two camp zones 215. In some embodiments, a worker or machine may scan a package (e.g., using one of devices 119A-119C) to determine its eventual destination. Routing the package to camp zone 215 may comprise, for example, determining a portion of a geographical area that the package is destined for (e.g., based on a postal code) and determining a camp zone 215 associated with the portion of the geographical area.

Camp zone 215, in some embodiments, may comprise one or more buildings, one or more physical spaces, or one or more areas, where packages are received from hub zone 213 for sorting into routes and/or sub-routes. In some embodiments, camp zone 215 is physically separate from FC 200 while in other embodiments camp zone 215 may form a part of FC 200.

Workers and/or machines in camp zone 215 may determine which route and/or sub-route a package 220 should be associated with, for example, based on a comparison of the destination to an existing route and/or sub-route, a calculation of workload for each route and/or sub-route, the time of day, a shipping method, the cost to ship the package 220, a PDD associated with the items in package 220, or the like. In some embodiments, a worker or machine may scan a package (e.g., using one of devices 119A-119C) to determine its eventual destination. Once package 220 is assigned to a particular route and/or sub-route, a worker and/or machine may move package 220 to be shipped. In exemplary FIG. 2, camp zone 215 includes a truck 222, a car 226, and delivery workers 224A and 224B. In some embodiments, truck 222 may be driven by delivery worker 224A, where delivery worker 224A is a full-time employee that delivers packages for FC 200 and truck 222 is owned, leased, or operated by the same company that owns, leases, or operates FC 200. In some embodiments, car 226 may be driven by delivery worker 224B, where delivery worker 224B is a “flex” or occasional worker that is delivering on an as-needed basis (e.g., seasonally). Car 226 may be owned, leased, or operated by delivery worker 224B.

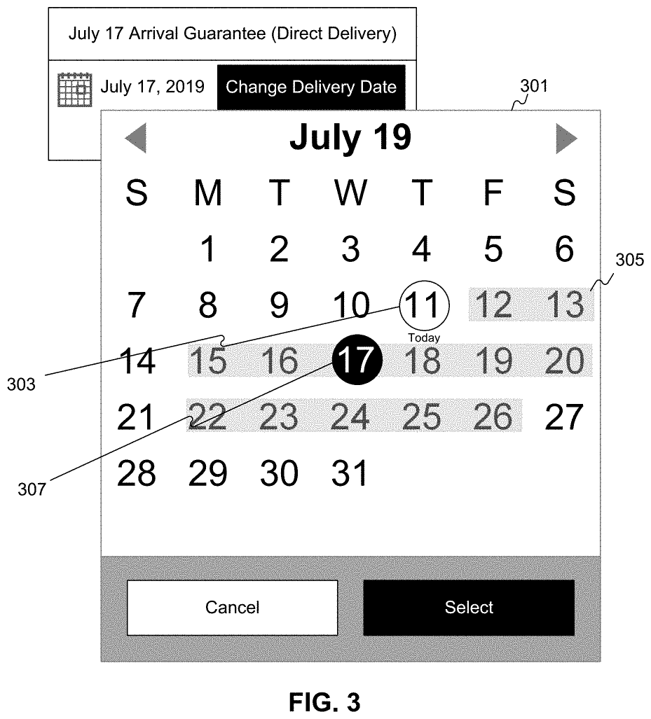

FIG. 3 depicts another sample calendar of guaranteed delivery dates displayed on a user device, consistent with the disclosed embodiments. A user device may receive a calendar 301 of guaranteed delivery dates associated with a request for a product from FO system 113, as explained above. Calendar 301 may mark today's date 303 and highlight calculated guaranteed delivery dates 305. A user may interact with a user interface element of the user device to provide a selection 307 of their desired guaranteed delivery date. The user interface element then sends the user's selection to external front end system 103 for processing the requested order.

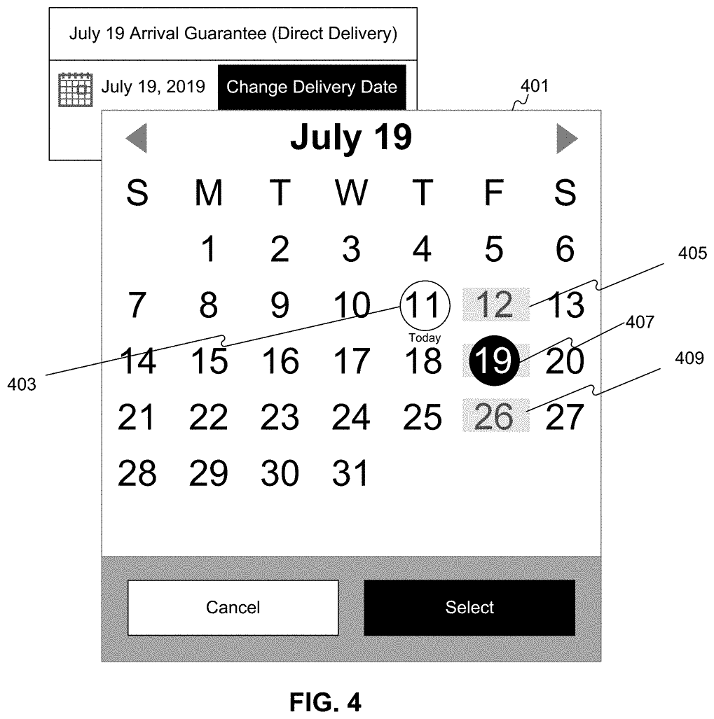

FIG. 4 depicts yet another sample calendar of guaranteed delivery dates displayed on a user device, consistent with the disclosed embodiments. A user device may receive a calendar 401 of guaranteed delivery dates associated with a request for a product from FO system 113, as explained above. Calendar 401 may mark today's date 403 and highlight calculated guaranteed delivery dates 405 and 407. In this example, the guaranteed delivery dates may only occur on Fridays. A user may interact with a user interface element of the user device to provide a selection 407 of their desired guaranteed delivery date. The user interface element then sends the user's selection to external front end system 103 for processing the requested order.

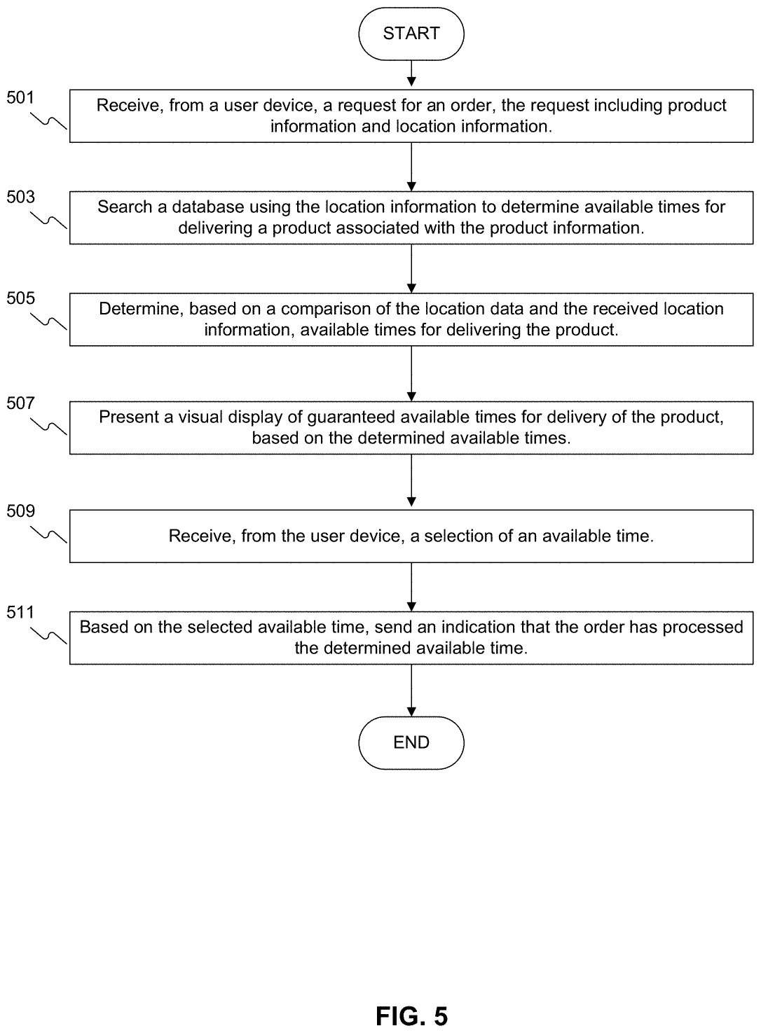

FIG. 5 depicts a process for providing guaranteed delivery dates to a user device, consistent with the disclosed embodiments.

In step 501, external front end system 103 may receive and process a request for an order from a user via an external device (e.g., mobile device 102A or computer 102B). The request may include product information (e.g., a product identifier) and location information (e.g., an address or zip code of the location to which the product is to be delivered). The request for an order may not include a desired time for the order since system 100 may provide external device 102A/102B with an option for the user to select a guaranteed delivery date from a selection of available, guaranteed delivery dates in a calendar.

In step 503, FO system 113 may search the database using location information (e.g., an address or zip code of the location to which the product is to be delivered) from a request for an order to determine available times for delivering a product associated with the product information. The database may include location data (e.g., the zip code and locations of warehouses containing the requested product), product data (e.g., product identifier, inventory of the requested product in warehouses), and time data (e.g., delivery staff, delivery schedule, delivery route).

In step 505, FO system 113 may determine available times (i.e., PDDs) for delivering the product based on a comparison of the location data and the received location information. The PDD may be calculated to exclude available times for delivery associated with vendors who have zero products in their inventory of a requested order and to include guaranteed available times for deliveries associated with vendors having greater than zero products in their inventory of a requested order. FO system 113 may calculate the PDD based on the inventory updates (including zip code data) received by WMS 119. In some embodiments, all vendors may provide inventory updates once per day, including inventory updates for zip codes outside of a metropolitan area. In some other embodiments, the vendors may provide inventory updates more or less frequently than once per day.

In some embodiments, when requests for orders exceed the inventory available for the associated product on a selected delivery date, external front end system 103 may send a notification to the associated vendor via seller portal 109. The vendor may then immediately contact (e.g., via telephone call) one or more users who requested an order to determine the PDD.

In some embodiments, a database is configured to determine whether an inventory value of a given request and its associated zip code are constrained (e.g., the zip code of the delivery location is outside the radius of a metropolitan area). WMS 119 may periodically (e.g., once per day, once per hour, etc.) send a request for an inventory update to all vendors via seller portal 109 to determine PDDs and to provide cost-effective and timely deliveries. WMS 119 may update the database to include an inventory update received from the vendors, the inventory update including zip code data for vendor warehouses associated with constrained zip codes. WMS 119 may be configured to update the database in real-time or to conditionally trigger an update based on an event. Accordingly, FO system 113 may periodically update PDDs based on the inventory updates and associated zip codes.

In some other embodiments, after PDDs are calculated and selected for a given request, external front end system 103 may determine that delivering a product from a first warehouse owned by a vendor (i.e., a seller) is more cost-effective (e.g., lower in shipping costs, reduced delivery time) than delivering the same product from a second warehouse owned by the vendor. Upon making this determination, external front end system 103 may automatically perform a “virtual swapping” of the product between the inventory of the two warehouses such that the product may be delivered from the first warehouse. External front end system 103 may perform the virtual swapping by sending a request to WMS 119 to modify a database via a first API to indicate that the first warehouse inventory has increased by one unit of the product and to modify the database via a second API to indicate that the second warehouse inventory has decreased by one unit of the product. A virtual swap may result in FO system 113 determining a new PDD that is earlier than the PDD selected by the user. FO system 113 may then send a notification to user device 102A/102B indicating the earlier PDD.

In step 507, FO system 113 may send the determined available times to user device 102A/102B, which may present a visual display of guaranteed available times for delivery of the product based on the determined available times. The visual display may be a calendar that highlights the guaranteed available times for delivery of the product associated with a user's requested order. For example, FO system 113 may provide user device 102A/102B with a calendar that highlights PDDs within the next fifteen days associated with a user's requested order.

In step 509, external front end system 103 may receive, from user device 102A/102B, a selection of an available time. The user may interact with a user interface element to select a PDD. The user interface element then sends the user's selection to external front end system 103 for processing the requested order. From there, external front end system 103 may send the information to different systems in system 100 to enable the creation and processing of a new order with the products in the shopping cart.

In step 511, based on the selected available time, external front end system 103 may send an indication to user device 102A/102B that the requested order, including the selected guaranteed available time for delivery, has been processed. In some embodiments, this indication may be sent to user device 102A/102B after confirmation from a fulfilling vendor.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

1. An electronic system for multi-computer logistics coordination, comprising:
at least one processor; and
at least one non-transitory storage medium comprising instructions that, when executed by the at least one processor, cause the at least one processor to perform steps comprising:
receiving, from a user device, a request for an order, the request including product information and location information;
searching a database using the location information to determine available times for delivering a product associated with the product information, the database comprising location data, product data, and time data, wherein searching the database comprises:
determining, based on the product information and the location information, a first delivery time of delivering the product from a first warehouse,
determining, based on the product information and the location information, a second delivery time of delivering the product from a second warehouse,
comparing the first delivery time and the second delivery time,
based on the comparison of the first delivery time and the second delivery time, determining that the product will be delivered from the first warehouse;
forecasting a level of network-wide demand for the product based on network-wide past demand of the product and a quantity of the product stored in a plurality of warehouses;
determining, based on a comparison of the location data, the received location information, and the forecasted level of network-wide demand for the product, available times for delivering the product;
modifying a user interface element on the user device to generate a visual display of guaranteed available times for delivery of the product, based on the determined available times;
receiving, from the user device, a selection of an available time; and
based on the selected available time, sending an indication to the user device that the order is processed and assigning the determined available time to the order.

2. (canceled)

3. The system of claim 1, wherein sending the indication is performed after confirmation from a fulfilling vendor

4. The system of claim 1, wherein the database further comprises postal code information.

5. The system of claim 4, wherein the database is configured to:
receive updated location data, product data, and time data associated with a first zip code; and
update the database to include the received update associated with the first zip code.

6. The system of claim 5, wherein the database is configured to:
determine that an inventory value associated with a second zip code is constrained;
receive updated location data, product data, and time data associated with the second zip code; and
update the database to include the received update associated with the second zip code.

7. The system of claim 1, wherein the request for an order does not comprise a desired time for the order.

8. The system of claim 1, wherein sending the indication is performed after confirmation from a fulfilling vendor.

9. The system of claim 1, wherein the product is a first product and the request for an order comprises a second product, further comprising:
determining, based on the product information and the location information, a first cost of delivering the second product from the first warehouse;
determining, based on the product information and the location information, a second cost of delivering the second product from the second warehouse;
comparing the first cost and the second cost;
based on the comparison of the first cost and the second cost:
modifying the database such that an inventory of the first warehouse is increased by one unit of the second product;
modifying the database such that an inventory of the second warehouse is decreased by one unit of the second product; and
determining that the second product will be delivered from the first warehouse.

10. A method for generating a calendar of guaranteed delivery times for user selection, comprising:
receiving, from a user device, a request for an order, the request including product information and location information;
searching a database using the location information to determine available times for delivering a product associated with the product information, the database comprising location data, product data, and time data, wherein searching the database comprises:
determining, based on the product information and the location information, a first delivery time of delivering the product from a first warehouse,
determining, based on the product information and the location information, a second delivery time of delivering the product from a second warehouse,
comparing the first delivery time and the second delivery time,
based on the comparison of the first delivery time and the second delivery time, determining that the product will be delivered from the first warehouse;
forecasting a level of network-wide demand for the product based on network-wide past demand of the product and a quantity of the product stored in a plurality of warehouses;
determining, based on a comparison of the location data, the received location information, and the forecasted level of network-wide demand for the product, available times for delivering the product;
modifying a user interface element on the user device to generate a visual display of guaranteed available times for delivery of the product, based on the determined available times;
receiving, from the user device, a selection of an available time; and
based on the selected available time, sending an indication to the user device that the order is processed and assigning the determined available time to the order.

11. (canceled)

12. The method of claim 10, wherein sending the indication is performed after confirmation from a fulfilling vendor

13. The method of claim 10, wherein the database further comprises postal code information.

14. The method of claim 13, wherein the database is configured to perform the steps of:
receiving updated location data, product data, and time data associated with a first zip code; and
updating the database to include the received update associated with the first zip code.

15. The method of claim 14, wherein the database is configured to perform the steps of:
determining that an inventory value associated with a second zip code is constrained;
receiving updated location data, product data, and time data associated with the second zip code; and
updating the database to include the received update associated with the second zip code.

16. The method of claim 15, wherein determining that the inventory value associated with the zip code is constrained comprises determining that the zip code is outside the radius of a metropolitan area.

17. The method of claim 10, wherein the request for an order does not comprise a desired time for the order.

18. The method of claim 10, wherein sending the indication is performed after confirmation from a fulfilling vendor.

19. The method of claim 10, wherein the product is a first product and the request for an order comprises a second product, further comprising:
determining, based on the product information and the location information, a first cost of delivering the second product from the first warehouse;
determining, based on the product information and the location information, a second cost of delivering the second product from the second warehouse;
comparing the first cost and the second cost;
based on the comparison of the first cost and the second cost:
modifying the database such that an inventory of the first warehouse is increased by one unit of the second product;
modifying the database such that an inventory of the second warehouse is decreased by one unit of the second product; and
determining that the second product will be delivered from the first warehouse.

20. An electronic system for multi-computer logistics coordination, comprising:
at least one processor; and
at least one non-transitory storage medium comprising instructions that, when executed by the at least one processor, cause the at least one processor to perform steps comprising:
receiving, from a user device, a request for an order, the request including product information and location information;
searching a database using the location information to determine available times for delivering a product associated with the product information, the database comprising location data, product data, and time data, wherein searching the database comprises:
determining, based on the product information and the location information, a first delivery time of delivering the product from a first warehouse,
determining, based on the product information and the location information, a second delivery time of delivering the product from a second warehouse,
comparing the first delivery time and the second delivery time,
based on the comparison of the first delivery time and the second delivery time, determining that the product will be delivered from the first warehouse;
forecasting a level of network-wide demand for the product based on network-wide past demand of the product and a quantity of the product stored in a plurality of warehouses;
determining, based on a comparison of the location data, the received location information, and the forecasted level of network-wide demand for the product, available times for delivering the product;
modifying a user interface element on the user device to generate a visual display of guaranteed available times for delivery of the product, based on the determined available times, the visual display comprising a calendar highlighting guaranteed available times for delivery of the product;
receiving, from the user device, a selection of an available time; and
based on the selected available time, sending an indication to the user device that the order is processed and assigning the determined available time to the order.
